(19) United States
(12) Patent Application Publication
(10) Pub. No.: US 2009/0171651 A1
(43) Pub. Date: Jul. 2, 2009

(54) SDRAM-BASED TCAM EMULATOR FOR IMPLEMENTING MULTIWAY BRANCH CAPABILITIES IN AN XML PROCESSOR

(76) Inventors: Jan Van Lunteren, Gattikon (CH); Heather D. Achilles, Hudson, NH (US); Joseph Allen, Belmont, MA (US); David J. Hoeweler, Cambridge, MA (US); Jeffrey M. Peters, Leominster, MA (US)

Correspondence Address: HOFFMAN WARNICK LLC, 75 STATE STREET, 14TH FLOOR, ALBANY, NY, 12207, US

(21) Appl. No.: 11/966,236

(22) Filed: Dec. 28, 2007

(51) Int. Cl. G06F 9/455

(52) U.S. Cl. 703/26

(57) ABSTRACT

The system and method of the present invention “emulates” the TCAM function using a data structure which is stored in an SDRAM device in such way that the size of emulated TCAM is substantially larger than the original TCAM device, thereby allowing the increase of the number of PPE programs which can be resident in memory. The present invention provides a new “emulCAM” algorithm which builds partially on BaRT, but is extended by providing multiple results per hash table entry with flexible assignment to “match-condition-combinations”, by utilizing MUX control vectors for extracting hash index instead of “index-mask-based extraction”, by moving part of CAM function to invoking emulCAM instruction and by providing “Pathological case handling” using multiple emulCAM instructions.

### BACKGROUND OF THE INVENTION

1. Field of the Invention

The present invention generally relates to memory. Specifically, the present invention provides a system and method for an SDRAM-based TCAM emulator for implementing multi-way branch capabilities in an XML processor.

2. Related Art

An SDRAM is a synchronous dynamic random access memory which is a type of solid state computer memory. Content-addressable memory (CAM) is a special type of computer memory used in certain very high speed searching applications. It is also known as associative memory, associative storage, or associative array, although the last term is more often used for a programming data structure.

DataPower's XG4's XML Post Processing Engine (PPE) is a processor with specialized instructions targeted for doing XML processing such as schema validation and SOAP lookups. (DataPower® is a product division within IBM that produces XML appliances for processing XML messages as well as any-to-any legacy message transformation (flat files, COBOL, text, etc.). DataPower was the first company to create network devices to perform XML processing, integrated application-specific integrated circuits (ASICs) designed to accelerate XML processing into products, and implement a broad XML-aware & application-oriented networking strategy.) One of the key PPE features is the ability to do a multi-way lookup and branch in one instruction. The PPE uses a Ternary Content Addressable Memory (TCAM) device for this purpose. Each TCAM entry corresponds to one particular branch and stores the conditions that have to be fulfilled for that particular branch to be selected in the form of a ternary match vector. When the PPE encounters a “CAM lookup” instruction, it creates a key that is sent to the TCAM and is compared simultaneously against all TCAM entries. If a TCAM entry (i.e., a branch) is found that matches the key, then the match location is sent as the address to a “next instruction memory” RAM which in turn produces the address of the next instruction (i.e., the branch target) the PPE should execute.

If multiple matches are found in the TCAM then a priority scheme implemented by the TCAM (typically based on the address order) is used to select one of the matching entries.

One of the challenges with today's XG4 design is that the size (i.e., the storage capacity) of the TCAM device limits the number of PPE programs which can be simultaneously loaded into memory at a given time.

Presently, it is not possible to use the original BaRT (balanced routing table) algorithm for the TCAM emulation. As such, a new algorithm is needed to meet the requirements for the TCAM emulation algorithm as described above.

The most important limitations of the original BaRT scheme for the TCAM emulation are the following:

Input Vector Size—Number of Memory Accesses

The original BaRT algorithm is able to efficiently process an input key in segments of about 8 bits, and performs a memory access for each of these segments. For example, a 32-bit IPv4 destination address is processed in four steps, each involving one byte from the destination address and one memory access.

For the TCAM emulation, the restriction is to a single memory access. Consequently, the entire input vector, which can be up to 50 bits wide, needs to be processed in a single step, which is far beyond the original 8 bits that BaRT can efficiently process in a single step.

Don't Care Bits/Ternary Match Conditions

A worst-case situation for BaRT occurs when hash index bits have to be extracted from bit positions in the input vector which are “don't care” in several of the search keys. (A hash function is a reproducible method of turning some kind of data into a (relatively) small number that may serve as a digital “fingerprint” of the data.) In that case, the latter search keys have to be replicated over multiple hash index values, resulting in a larger size of the data structure. When processing the input value in segments of about 8 bits as described above, the effect of this is not very large, and BaRT will achieve an extremely compact data structure.

For the TCAM emulation, however, the requirement to process the entire 50-bit input vector as a whole, in combination with various “don't care”/ternary match conditions on portions of the input vector as specified by the TCAM entries (branch conditions), this effect is not negligible, and results in a storage explosion for certain combinations of branch conditions.

Number of Collisions per Hash Index Value (P)

A larger value for P typically results in higher storage efficiency because the compiler/update function has more freedom to map rules on the hash table, while rules with overlapping conditions (e.g., wildcards) can be resolved by the parallel comparison function of BaRT.

Because the TCAM emulation lookup has to process the entire input vector in a single step, the resulting BaRT entries become much wider as well. Given that the external SDRAM has a width of 128 bits, one is able to implement BaRT only with a collision bound P equal to 1 thus eliminating all the additional flexibility and gain which could have been obtained with higher values of P.

Extraction of the Hash Index Value

The BaRT algorithm stores for each hash table (“hash tables”, a major application for hash functions, enable fast lookup of a data record given its key) in the data structure, a so-called index mask which defines the bits which will be extracted from the input value/segment in order to ? from the hash index. For example, an index mask equal to “00101101”b indicates that (assuming IBM notation: b0 b1 b2 b3. . . b7) bits b2, b4, b5 and b7 need to be extracted from the 8-bit input segment, and need to be justified and aligned to form a hash index.

As the above example shows, the extraction (selection) of the most significant hash index bit can depend on the entire index mask in order to perform the correct justification and alignment. Consequently, this will determine the critical path/complexity of the search function and the latency of the extraction function.

With the TCAM emulation, the index value needs to be extracted from a much wider input vector. As a result, the original specification of the hash function using an index mask results in a substantially more complex and thus slower implementation of the index extraction function, because this would involve a very wide index mask, possibly up to 50 bits. As such, a new lookup algorithm is needed to meet the requirements for the TCAM emulation algorithm as described above.

### SUMMARY OF THE INVENTION

The new lookup algorithm of the present invention is derived from the BaRT (Balanced Routing Table) search algorithm, which was originally developed for routing table lookups, but can be applied to a wide range of exact-, prefix- and range-match searches. The BaRT algorithm consists of a type of hash function, in which the hash index is formed by a subset of bits from the input vector. These bits are selected in such a way that the number of collisions for each hash index value is bounded to a configurable parameter P. The value of P depends on implementation aspects, in particular the memory width, and is chosen such that the (at most) P entries stored in each location in the hash table, can be retrieved in a single memory access.

The system and method of the present invention “emulates” the TCAM function using a data structure which is stored in an SDRAM device in such way that the size of emulated TCAM is substantially larger than the original TCAM device, thereby allowing the increase of the number of PPE programs which can be resident in memory.

The present invention overcomes the issues listed previously by providing a new “emulCAM” algorithm which builds partially on BaRT, but is extended in the following ways to resolve all above issues:
a. by providing multiple results per hash table entry with flexible assignment to “match-condition-combinations”;
b. by utilizing MUX control vectors for extracting hash index instead of “index-mask-based extraction”;
c. by moving part of CAM function to invoking emulCAM instruction; and
d. by providing “Pathological case handling” using multiple emulCAM instructions.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system suitable for storing and/or executing program code, such as the program code of the present invention.

FIG. 2 shows an illustrative communication network for implementing the method of the present invention.

FIG. 3 shows an emulCAM instruction with corresponding hash table in SDRAM of the present invention.

FIG. 4 shows the format of the emulCAM instruction of the present invention.

FIG. 5 shows an example of the format of a type of emulCAM instruction is illustrated of the present invention.

FIG. 6 illustrates the QName field and the format of a hash table entry.

FIG. 7 illustrates the format of a hash table entry, which is contains two additional fields besides the QName, namely the Depth and RelDepth fields, and also includes a so called Match Flag field associated with each result field.

FIG. 8 illustrates results for various collections of CAM entries (corresponding to different PPE programs).

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE PREFERRED EMBODIMENTS

The present invention provides a system and method for an SDRAM-based TCAM emulator for implementing multi-way branch capabilities in an XML processor.

The present invention solves this problem through a lookup algorithm that “emulates” the TCAM function using a data structure that is stored in an SDRAM device, in such way, that the size of emulated TCAM is substantially larger than the original TCAM device, allowing the increase of the number of PPE programs which can be resident in memory.

In order to realize this, the present invention solves the following two key challenges:

1) For performance reasons, only a single memory access is made to the SDRAM device to emulate a “TCAM lookup”. Only in exceptional cases, more than one SDRAM access is performed.

2) The lookup algorithm is very storage efficient: although SDRAM technology is much denser than TCAM technology, the SDRAM needs to store a larger number of branch entries (by at least a factor 5) while it will also be used to store other instruction data.

The original TCAM is emulated using a data structure which contains a separate hash table for each “current instruction pointer” value, in which all original TCAM entries are stored that relate to that current instruction pointer. These hash tables are stored in an SDRAM. When the PPE sees an emulCAM instruction, it triggers a lookup operation on the hash table, comprised of generating a hash index value, accessing the external SDRAM to fetch the corresponding hash table entry, and performing a compare operation of the retrieved hash table entry with the original key to determine the lookup result. For this purpose, the emulCAM instruction contains the pointer to the hash table and also information on how the hash index has to be generated from the input key.

In addition, the emulCAM instruction also contains data which was part of the original CAM instruction. A variation of this concept involves the creation of a hash table for the CAM entries that relate to the same instruction pointer and markup type. The test on the markup type is then performed as part of the emulCAM instruction. In case of multiple markup types, the emulCAM instruction contains multiple hash table pointers and hash index information, one for each markup type.

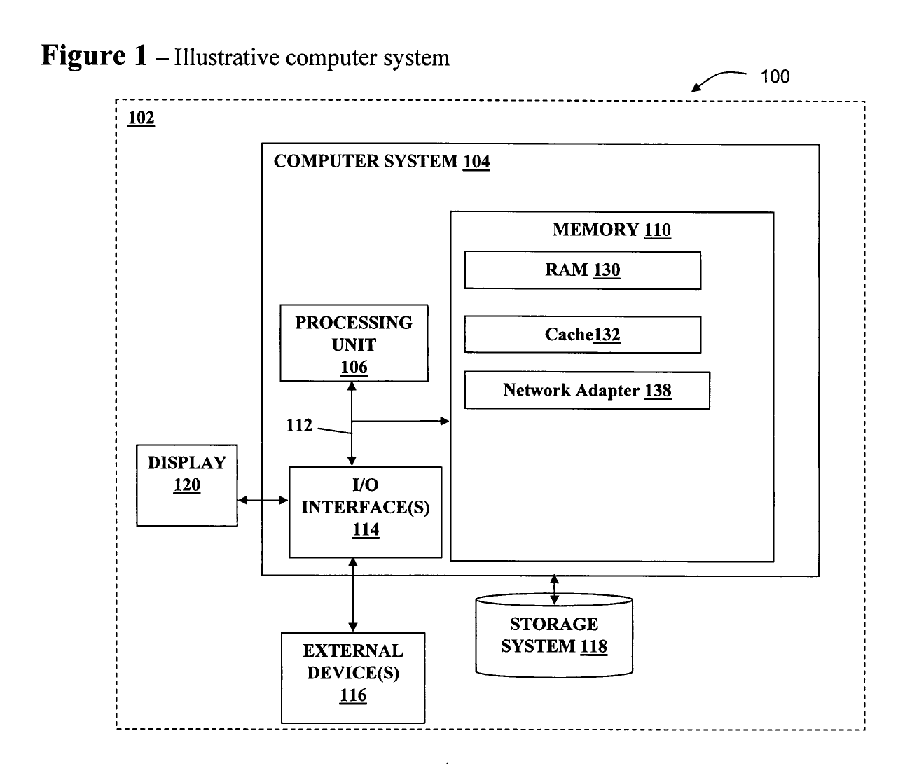

A data processing system, such as that system 100 shown in FIG. 1, suitable for storing and/or executing program code, such as the program code of the present invention, will include at least one processor (processing unit 106) coupled directly or indirectly to memory elements through a system bus. The memory elements can include local memory (RAM 130) employed during actual execution of the program code, bulk storage (storage 118), and cache memories (cache 132) which provide temporary storage of at least some program code in order to reduce the number of times code must be retrieved from bulk storage during execution. Input/output or I/O devices (external devices 116) (including but not limited to keyboards, displays, pointing devices, etc.) can be coupled to the system either directly or through intervening I/O controllers (I/O Interface 114).

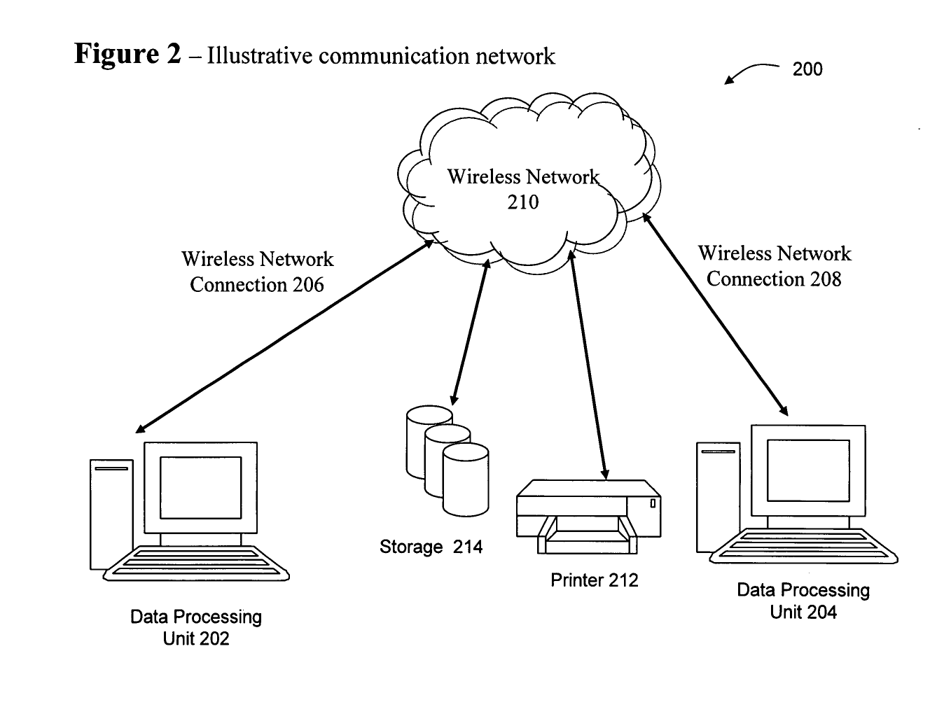

Network adapters (network adapter 138) may also be coupled to the system to enable the data processing system (as shown in FIG. 2, data processing unit 102) to become coupled to other data processing systems (data processing unit 204) or remote printers (printer 212) or storage devices (storage 214) through intervening private or public networks (network 210). (A computer network is composed of multiple computers connected together using a telecommunication system for the purpose of sharing data, resources and communication. For more information, see http://historyoftheinternet.org/). Modems, cable modem and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

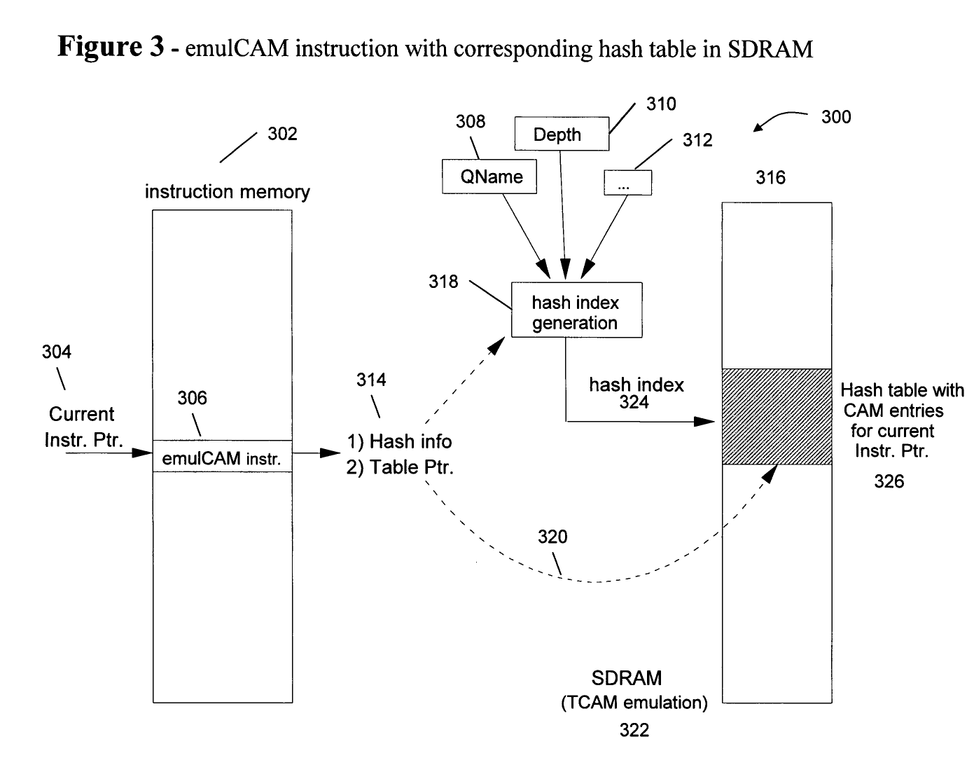

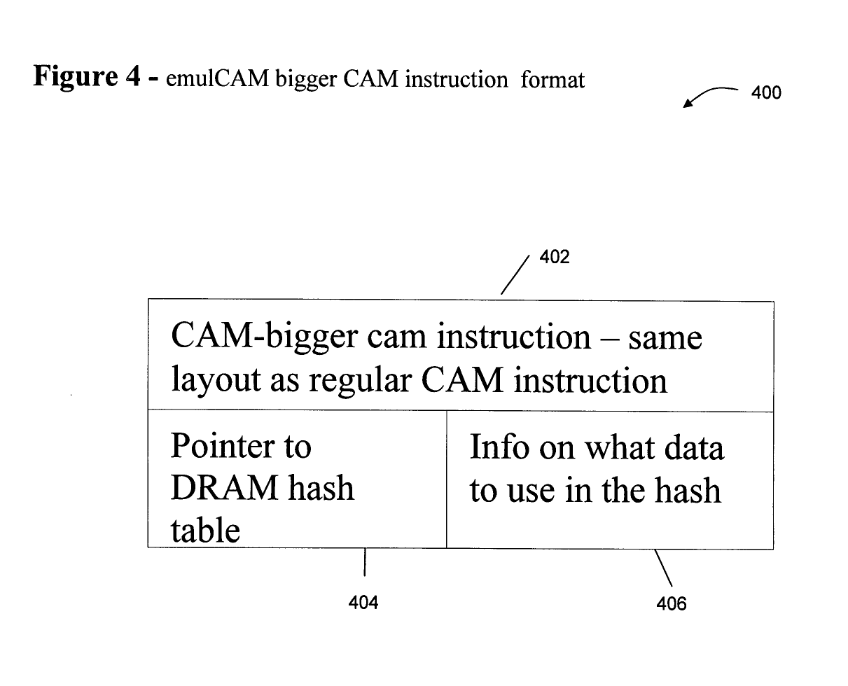

FIG. 3 illustrates an example in which an emulCAM instruction 306 in the instruction memory 302 refers to a hash table 326 stored in SDRAM 322 that stores the CAM entries related to the instruction pointer value 304. FIG. 4 illustrates the format 400 of the emulCAM instruction which comprises a CAM-bigger instruction 402, a pointer to the DRAM hash table 404, and information on what data to use in the hash 406.

During the execution of the emulCAM instruction 306, a hash index 324 is generated from several input fields (such as QName 308, Depth 310, and other information 312), based on information 406 provided by the emulCAM instruction 306. Next, the memory address of the selected hash table entry is calculated by adding the hash index 318 to the table pointer 404, and the SDRAM 322 is accessed to fetch the selected hash table entry.

Through a specific alignment of the hash tables, there is no need to perform an actual add operation for generating the memory address as described above, but instead only a simple bit-wise OR operation is performed.

The BaRT algorithm uses an index mask to define how a hash index is generated from the input key. As indicated above, this does not work very well for the wide input vector involved in the TCAM emulation, because it would result in a complex and slow index extraction function in hardware. Instead, the emulCAM instruction does not use an index mask, but uses k MUX control vectors, one for each of a total of k hash index bits which are extracted from the input vector. For example, the first MUX control vector is used to directly control the multiplexer function in hardware which selects the bit from the input vector which is extracted at bit location 0 in the hash index. The second MUX control vector does the same for bit location 1 in the hash index, and so on. Although this results in more bits compared to the original index mask (which would be 50 bits for a 50-bit input vector), it allows for a substantially faster implementation, because the selection of each hash index bit only depends on the corresponding MUX control vector, and not on the entire index mask as would be the case with the original BaRT approach. If this concept would be applied on the previous example discussed above, which involved an index mask “00101101”b to extract bits b2, b4, b5 and b7 from an input value, then the following MUX control vectors are used (IBM notation):

Hash index bit 7: “MUX control vector to select bit 7 from input vector”

Hash index bit 6: “MUX control vector to select bit 5 from input vector”

Hash index bit 5: “MUX control vector to select bit 4 from input vector”

Hash index bit 4: “MUX control vector to select bit 2 from input vector”

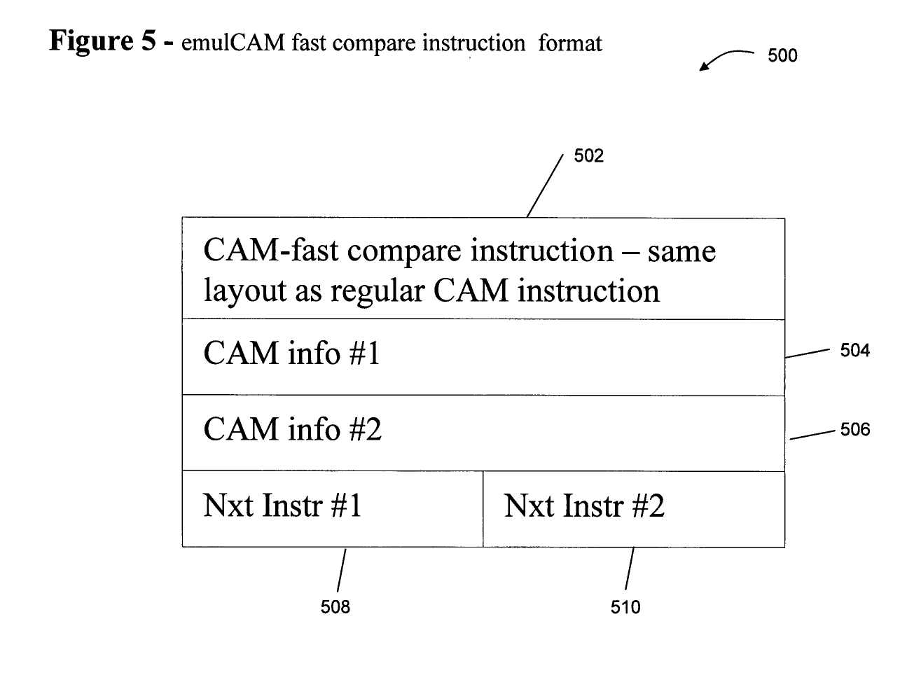

A second performance improvement is obtained for instruction pointers for which only a few related CAM entries exist. Instead of creating a hash table in external memory for these instruction pointers, now these few corresponding CAM entries are directly integrated into an extended version of the emulCAM instruction and executed as part of the instruction. This optimization improves overall performance for PPE programs which contain a relatively large number of instruction pointers with few corresponding CAM entries. In that case, the latency involved in a lookup on the external SDRAM can be entirely removed in this way. An example of the format of this type of emulCAM instruction is illustrated in FIG. 5. emulCAM instruction 500 has a CAM-fast compare instruction field 502, CAM information #1 504, CAM information #2 506, Nxt Instr #1 508, and Nxt Instr #2 510.

As listed above, a worst-case situation for BaRT can occur when hash index bits have to be extracted from bit positions in the input vector which are “don't care” in several of the search keys. In that case, the latter search keys have to be replicated over multiple hash index values, resulting in a larger size of the data structure.

An example of such a situation is illustrated using the following CAM entries listed by decreasing priority:
entry 1: I=0009f/fffff T=11/bf Q=001d01cf/ffffffff D=00/00 F=0/0→0023b
entry 2: I=0009f/fffff T=11/bf Q=001d01d0/ffffffff D=00/00 F=0/0→00242
entry 3: I=0009f/fffff T=11/bf Q=001d01d1/ffffffff D=00/00 F=0/0→00244
entry 4: I=0009f/fffff T=11/bf Q=001d01d2/ffffffff D=00/00 F=0/0→00246
entry 5: I=0009f/fffff T=11/bf Q=001d01d3/ffffffff D=00/00 F=0/0→00248
entry 6: I=0009f/fffff T=11/bf Q=001d01d4/ffffffff D=00/00 F=0/0→0024a
entry 7: I=0009f/fffff T=11/bf Q=001d01d5/ffffffff D=00/00 F=0/0→0024c
entry 8: I=0009f/fffff T=11/bf Q=001d0000/ffff0000 D=00/00 F=0/0→000a0
entry 9: I=0009f/fffff T=11/bf Q=00000000/ffff0000 D=00/00 F=0/0→>000a0
entry 10: I=0009f/fffff T=11/bf Q=00000000/00000000 D=00/00 F=0/0→00252

In this example, one focuses only on the QName field and QName mask—the other fields are either all equal or all “don't care”. The match condition on QName field is specified in the following way:

Q=<32-bit base value>/<32-bit mask value>

The base and mask value together comprise a ternary match condition, in which the actual QName value is compared with the base value only at the bit positions at which the mask value contains a set bit. The CAM entries corresponding to the multi-way branches executed by the PPE have the property that the mask field can only have one out of the following four possible values: FFFFFFFFh, FFFF0000h, 0000FFFFh, 00000000h.

These values correspond to a match condition specified for the entire 32-bit QName, a match condition specified for the most significant 16 bits of the QName, a match Condition specified for the least significant bits of the QName, and a “don't care” condition for the QName, respectively.

If one would apply the original BaRT scheme to create a hash table for the above entries with the number of collisions per hash index value bounded by P=1 (see above), then the following applies. For example, in order to be able to distinguish between matches on CAM entry 7 and 8, all 16 least significant bits of the QName need to be checked: only in that way it can be checked if CAM entry 7 applies (i.e., 16 least significant bits equal “01D5”h) or if CAM entry 8 applies (i.e., the 16 least significant bits equal any value except “01D5”h).

Furthermore, in order to be able to distinguish between entries 8 and 9, at least one bit of the 16 most significant QName bits has to be tested (e.g., bit 15—IBM notation). The most problematic entry, however, is entry 10. In order to distinguish between a match on entry 10 (which is a “don't care” condition) and the other CAM entries, the original BaRT algorithm would need to test all 32 bits of the QName. This particular case, however, can be resolved by storing the result associated with entry 10 as a default value within the emulCAM instruction which will be selected if no match is found on the other CAM entries.

Therefore, assuming the default solution described above, for this particular example, the hash index would consist of a total of 17 bits if the original BaRT scheme would have been applied, resulting in a large hash table with 2̂17=128K entries.

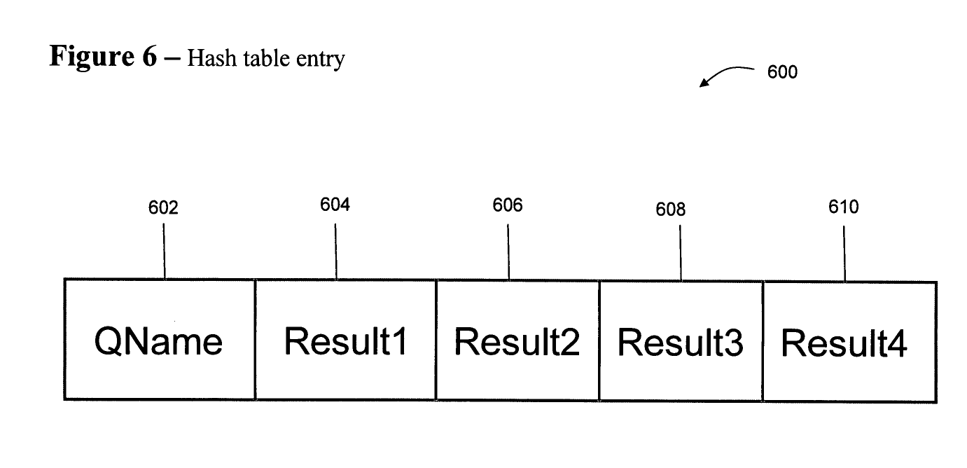

The above situation can be optimized substantially by storing multiple result vectors in each hash table entry, which relate to different combinations of match results on the stored fields. This will now be explained using an example that only focuses on the QName field 602 and involves the format of a hash table entry 600 illustrated in FIG. 6.

The hash table entry 600 shown in FIG. 6 contains four result vectors 604, 606, 608, 610 which correspond to the following match results for comparing the actual QName value with the stored value in the QName field 602:

Result1 (604) is selected in case the entire QName value matches the entire 32-bit QName field 602;

Result2 (606) is selected in case the QName value matches only the 16 most significant bits of the QName field 602;

Result3 (608) is selected in case the QName value matches only the 16 least significant bits of the QName field 602; and

Result4 (610) is selected in case the QName does not match the QName field 602 in any of the above ways.

The compare function of the emulCAM instruction selects the appropriate result vector based on the comparison results.

Based on the above format of the hash table entry, the B-FSM compiler/update function has derived the following hash table for the CAM entries:

Hash Table—Index Mask=0x00010007
0000: Q=0000FFFF RES1=RES2=0000A0 RES3=RES4=000252
0001: Q=0000FFFF RES1=RES2=0000A0 RES3=RES4=000252
0002: Q=0000FFFF RES1=RES2=0000A0 RES3=RES4=000252
0003: Q=0000FFFF RES1=RES2=0000A0 RES3=RES4=000252
0004: Q=0000FFFF RES1=RES2=0000A0 RES3=RES4=000252
0005: Q=0000FFFF RES1=RES2=0000A0 RES3=RES4=000252
0006: Q=0000FFFF RES1=RES2=0000A0 RES3=RES4=000252
0007: Q=0000FFFF RES1=RES2=0000A0 RES3=RES4=000252
0008: Q=001D01D0 RES1=000242 RES2=0000A0 RES3=RES4=000252
0009: Q=001D01D1 RES1=000244 RES2=0000A0 RES3=RES4=000252
000A: Q=001D01D2 RES1=000246 RES2=0000A0 RES3=RES4=000252
000B: Q=001D01D3 RES1=000248 RES2=0000A0 RES3=RES4=000252
000C : Q=001D01D4 RES1=00024A RES2=0000A0 RES3=RES4=000252
000D: Q=001D01D5 RES1=00024C RES2=0000A0 RES3=RES4=000252
000E: Q=001DFFFF RES1=RES2=0000A0 RES3=RES4=000252
000F: Q=001D01CF RES1=00023B RES2=0000A0 RES3=RES4=000252

In this case, the index mask equals “00010007”h, meaning that the hash index consists of four bits only, which are extracted from bit 15 and bits 29 to 31 of the QName (IBM notation). This corresponds to a hash table size of 16 entries which is substantially smaller than the size of 128K entries for the situation that the original BaRT algorithm was applied.

For example, for the following two QName values, “001D01D1”h and “001D1234”h, a lookup on the original CAM entries listed above would result in a match on entry 3 and entry 8 respectively, with corresponding results equal to 0244 and 00a0. The emulCAM lookup applied on these values would involve the extraction of bits 15 and 29 to 31 (as described above) as hash index, which are underlined in the following binary vectors:

“001D01D1”h=“0000 0000 0001 11010000 0001 1101 0001”b→resulting hash index: 1001b is 9h

“001D1234”h=“0000 0000 0001 1101 0001 0010 0011 0100”b→resulting hash index: 1100b is Ch

Consequently, for QName value “001D01D1”h, a lookup is made on hash table entry 9h. The QName field 602 contained in this entry equals “001D01D1”h. Comparing the QName value with the QName field 602 results in an exact match on the entire 32-bit vector. As a result, result vector Result1 604 is selected which equals 0244. This is the correct result corresponding to the original CAM entry 3.

Similarly, for QName value “001D1234”h, a lookup is made on hash table entry Ch. The QName field 602 contained in this entry equals “001D01D4”h. Comparing the QName value with the QName field results in a match only on the 16 most significant bits. As a result, result vector Result2 606 is selected which equals 00A0. This is the correct result corresponding to the original CAM entry 8.

There are multiple fields in each CAM entry. In order to handle all these fields efficiently, the above concept of multiple result vectors has been extended by enabling a flexible assignment of each result vector to a combination of matches on the various fields and/or field segments.

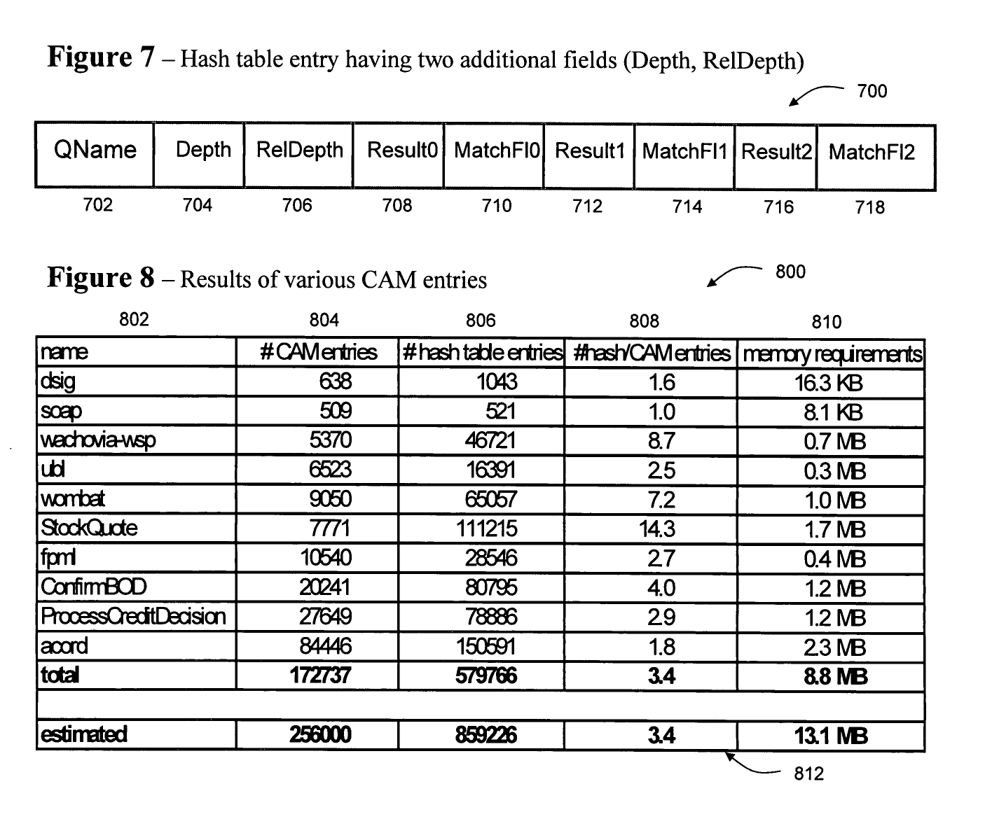

FIG. 7 illustrates the format of a hash table entry 700, which is contains two additional fields besides the QName 702, namely the Depth 704 and RelDepth 706 fields, and also includes a so called Match Flag field 710, 714, 718 associated with each result field 708, 712, 716.

In this example, it is assumed that the Markup type is handled in the emulCAM instruction. The presented concept can be directly applied in the same fashion to support additional fields beyond the ones listed and discussed here.

The Match Flag field 710, 714, 718 contains a specification that defines to which combination of match results the associated result vector corresponds to. This concept will be illustrated using the example of the hash table entry format 600 shown in FIG. 6. In that example, there are four results 604, 606, 608, 610 corresponding to match combinations on the most and least significant 16-bit segments of the QName 602. Those match combinations can be coded using a 2-bit Match Flag (MF) field in the following way:

MF=11: corresponding result will be selected in case the entire QName value matches the entire 32-bit QName field;

MF=10: corresponding result will be selected in case the QName value matches only the 16 most significant bits of the QName field;

MF=01: corresponding result will be selected in case the QName value matches only the 16 least significant bits of the QName field; and

MF=00: corresponding result will be selected in case the QName does not match the QName field in any of the above ways.

This can now be extended directly with match conditions on other fields. For example, the MF can be extended with two bits for the Depth and RelDepth field (at the most significant bit location in this example), which will result in the following additional “conditions” to be added to the above four combinations:

MF=x1xx: corresponding result will only be selected in case of a match on the Depth field;

MF=x0xx: corresponding result will only be selected in case of no match on the Depth field;

MF=1xxx: corresponding result will only be selected in case of a match on the RelDepth field; and

MF=0xxx: corresponding result will only be selected in case of no match on the RelDepth field.

For example, MF=0101 would now specify that the corresponding result will only be selected in case of a match on the upper 16-bits of the QName field and a match on the Depth field, but no match on the RelDepth field.

Obviously, various encodings of the MF field will allow to specify more flexible combinations of match conditions, including “don't care” conditions on entire fields, and also match conditions at the level of smaller segments within a given field (similar as with the QName).

The emulCAM instruction and lookup, as described above, provides a solution that meets the initial requirements as listed above. Experiments with actual CAM data have shown that the emulCAM instruction and lookup achieves excellent storage efficiency and fast lookup performance while taking only a single memory access for each emulCAM lookup operation.

For cost and efficiency reasons, the implementation of the emulCAM instruction will be optimized for the common case. This affects, in particular, the maximum width of a hash index vector and the number of result vectors which are stored in each hash table. As of these implementation restrictions, there exists a very small probability that a “pathological case” can occur for a set of CAM entries with a very specific combination of properties which cannot be handled due to a very large storage consumption exceeding the storage capacity of the SDRAM.

In this case, a so called “pathological case” handling mechanism is applied, which is able to catch these situations. This mechanism consists of distributing the CAM entries for which the construction of a single hash table as described above, would be problematic, over two or multiple different hash tables which are searched through a sequence of two consecutive or more emulCAM instructions. As described above, one of the possible reasons for large storage requirements is a combination of a large number of CAM entries each imposing a different type of “don't care” conditions on the same field or set of fields. If the hash index width (as supported in the hardware implementation) is not sufficient or if there is not sufficient result vectors in each hash table entry to handle all combinations efficiently, then the “conflicting” CAM entries can simply be distributed over different hash tables, which are searched in a consecutive matter. In this case, a priority scheme is applied to select the higher priority result in case multiple emulCAM instructions result in a match. Such a priority scheme can be implemented by assigning a priority to each emulCAM instruction and/or to each result in the hash table structure. Because CAM entries which do not overlap can be assigned the same priority, the number of different priorities is very small.

A prototype of the emulCAM lookup function has been implemented in VHDL. (VHDL (VHSIC hardware description language) is commonly used as a design-entry language for field-programmable gate arrays and application-specific integrated circuits in electronic design automation of digital circuits.) A prototype of the corresponding compiler/update function has been implemented in C-code. The table 800 in FIG. 8 shows results for various collections of CAM entries (corresponding to different PPE programs), whose names are listed in the first column (name) 802. The second column (#CAM entries) 804 shows the total number of CAM entries included in each collection. The third column (#hash table entries) 806 shows the total number of hash table entries, i.e., the accumulated size, of all hash tables that have been generated for these CAM entries. The fourth column (#hash/CAM entries) 808 shows the ratio between the total number of hash entries and the total number of CAM entries. The fifth column (memory requirements) 810 shows the total memory requirements of all hash tables together, based on an 128-bit hash table entry.

As can be seen from the table, on average 3.4 hash tables entries are needed for each CAM entry. Given all the restrictions as discussed above, in particular the restriction that only a single SDRAM access can be made for each emulCAM lookup, in combination with the wide input vector of up to 50 bits with a various combinations of “don't care” conditions on the multiple fields and field segments, this average of 3.4 is an excellent result allowing to emulate the TCAM in a fast and very storage efficient way. The bottom row in the table 812 indicates that a 256K-entry CAM (which is 4 times larger than the current 64K entry-CAM) can be emulated using a total of only 13 MB SDRAM storage. Given that one would expect to use a 256 MB SDRAM, this will only utilize about 5% of the available SDRAM storage capacity.

It should be understood that the present invention is typically computer-implemented via hardware and/or software. As such, client systems and/or servers will include computerized components as known in the art. Such components typically include (among others) a processing unit, a memory, a bus, input/output (I/O) interfaces, external devices, etc.

While shown and described herein as a system and method for an SDRAM-based TCAM emulator for implementing multi-way branch capabilities in an XML processor, it is understood that the invention further provides various alternative embodiments. For example, in one embodiment, the invention provides a computer-readable/useable medium that includes computer program code to enable a computer infrastructure an SDRAM-based TCAM emulator for implementing multi-way branch capabilities in an XML processor. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method, in a system comprising a Post Processing Engine (PPE), an instruction memory for receiving instruction pointers, and an external synchronous dynamic random access memory (SDRAM), for providing an SDRAM-based ternary content addressable memory (TCAM) emulator for implementing multi-way branch capabilities in an XML processor, the method comprising the steps of:
a. providing a data structure containing a separate hash table, for each instruction pointer value, in which all original TCAM entries are stored which relate to the instruction pointer;
b. storing the hash tables in the external SDRAM;
c. receiving an instruction pointer having a key;
d. generating an emulCAM instruction based upon the instruction pointer;
e. generating a hash index;
f. accessing the external SDRAM to fetch the hash table entry corresponding to the hash index; and
g. performing a compare operation of the retrieved hash table entry with the original key to determine the lookup result.

2. The method of claim 1 wherein the emulCAM instruction generating step comprises the step of adding the received instruction pointer value to the emulCAM instruction and the step of adding information on how the hash index is to be generated from the input key to the emulCAM instruction.

3. The method of claim 2 wherein the hash index generating step comprises the step of using the information on how the hash index is to be generated from the input key to generate the hash index.

4. The method of claim 3 wherein the information on how the hash index is to be generated from the input key in the emulCAM instruction comprises QName data and Depth data.

5. The method of claim 1 further comprising the steps of receiving an input vector and extracting k hash index bits from the input vector and further wherein the emulCAM instruction generating step comprises the step of using k multiplexer control vectors, one for each of a total of k hash index bits which are extracted from the input vector.

6. The method of claim 5 further comprising the step of determining whether the hash index width is insufficient and the step of determining whether that there is insufficient multiplexer control vectors and, if so, the step of distributing the CAM entries of multiple hash tables and the step of searching the multiple hash tables in a consecutive manner utilizing multiple emulCAM instructions.

7. The method of claim 6 further comprising the step of assigning a priority to each emulCAM instruction.

8. The method of claim 6 further comprising the step of assigning a priority to each result in the hash table structure.

9. The method of claim 1 further comprising the step of calculating the memory address of the selected hash entry by adding the hash index to the instruction pointer and further comprising the step of accessing the SDRAM to fetch the selected hash table entry.

10. A method, in a system comprising a Post Processing Engine (PPE) and an instruction memory for receiving instruction pointers, for providing a ternary content addressable memory (TCAM) emulator for implementing multi-way branch capabilities in an XML processor, the method comprising the steps of:
a. receiving an instruction pointer having a key;
b. generating an emulCAM instruction based upon the instruction pointer;
c. integrating CAM entries corresponding to the instruction pointer directly into the emulCAM instruction; and
d. executing the CAM entries as part of the emulCAM instruction execution.

11. A computer program product in a computer readable medium for implementing a method, in a system comprising a Post Processing Engine (PPE), an instruction memory for receiving instruction pointers, and an external synchronous dynamic random access memory (SDRAM), for providing an SDRAM-based ternary content addressable memory (TCAM) emulator for implementing multi-way branch capabilities in an XML processor, the method comprising the steps of:
a. providing a data structure containing a separate hash table, for each instruction pointer value, in which all original TCAM entries are stored which relate to the instruction pointer;
b. storing the hash tables in the external SDRAM;
c. receiving an instruction pointer having a key;
d. generating an emulCAM instruction based upon the instruction pointer;
e. generating a hash index;
f. accessing the external SDRAM to fetch the hash table entry corresponding to the hash index; and
g. performing a compare operation of the retrieved hash table entry with the original key to determine the lookup result.

12. The computer program product of claim 11 wherein the emulCAM instruction generating step comprises the step of adding the received instruction pointer value to the emulCAM instruction and the step of adding information on how the hash index is to be generated from the input key to the emulCAM instruction.

13. The computer program product of claim 12 wherein the hash index generating step comprises the step of using the information on how the hash index is to be generated from the input key to generate the hash index.

14. The computer program product of claim 13 wherein the information on how the hash index is to be generated from the input key in the emulCAM instruction comprises QName data and Depth data.

15. The computer program product of claim 11 wherein the method further comprises the steps of receiving an input vector and extracting k hash index bits from the input vector and further wherein the emulCAM instruction generating step comprises the step of using k multiplexer control vectors, one for each of a total of k hash index bits which are extracted from the input vector.

16. The computer program product of claim 15 wherein the method further comprises the step of determining whether the hash index width is insufficient and the step of determining whether that there is insufficient multiplexer control vectors and, if so, the step of distributing the CAM entries of multiple hash tables and the step of searching the multiple hash tables in a consecutive manner utilizing multiple emulCAM instructions.

17. The computer program product of claim 16 wherein the method further comprises the step of assigning a priority to each emulCAM instruction.

18. The computer program product of claim 16 wherein the method further comprises the step of assigning a priority to each result in the hash table structure.

19. A computer program product in a computer readable medium for implementing a method, in a system comprising a Post Processing Engine (PPE) and an instruction memory for receiving instruction pointers, for providing a ternary content addressable memory (TCAM) emulator for implementing multi-way branch capabilities in an XML processor, the method comprising the steps of:
a. receiving an instruction pointer having a key;
b. generating an emulCAM instruction based upon the instruction pointer;
c. integrating CAM entries corresponding to the instruction pointer directly into the emulCAM instruction; and
d. executing the CAM entries as part of the emulCAM instruction execution.

20. An SDRAM-based TCAM emulator for implementing multi-way branch capabilities in an XML processor comprising:
a Post Processing Engine (PPE);
an instruction memory for receiving instruction pointers and for generating at least one emulCAM instruction based upon the instruction pointer;
an external synchronous dynamic random access memory (SDRAM) having a data structure containing a separate hash table, for each instruction pointer, in which all original TCAM entries are stored which relate to the instruction pointer; and
a hash index generator for generating a hash index,
wherein the PPE accesses the external SDRAM to fetch the hash table entry corresponding to the hash index and performs a compare operation of the retrieved hash table entry with the original key to determine the lookup result.

21. The SDRAM-based TCAM emulator of claim 20 wherein the emulCAM instruction generator adds the received instruction pointer value to the emulCAM instruction and adds the information on how the hash index is to be generated from the input key to the emulCAM instruction.

22. The SDRAM-based TCAM emulator of claim 21 wherein the hash index generator uses the information on how the hash index is to be generated from the input key to generate the hash index.

23. The SDRAM-based TCAM emulator of claim 22 wherein the information on how the hash index is to be generated from the input key in the emulCAM instruction comprises QName data and Depth data.

24. The SDRAM-based TCAM emulator of claim 20 wherein the instruction memory receives an input vector and the PPE extracts k hash index bits from the input vector and further wherein the emulCAM instruction generator uses k multiplexer control vectors, one for each of a total of k hash index bits which are extracted from the input vector.

25. The SDRAM-based TCAM emulator of claim 24 wherein the PPE determines whether the hash index width is insufficient and determines whether that there is insufficient multiplexer control vectors and, if so, distributes the CAM entries of multiple hash tables and searches the multiple hash tables in a consecutive manner utilizing multiple emulCAM instructions.

26. The SDRAM-based TCAM emulator of claim 25 wherein the PPE assigns a priority to each emulCAM instruction.

27. The SDRAM-based TCAM emulator of claim 25 wherein the PPE assigns a priority to each result in the hash table structure.

28. A SDRAM-based TCAM emulator for providing a ternary content addressable memory (TCAM) emulator for implementing multi-way branch capabilities in an XML processor, the emulator comprises:
a Post Processing Engine (PPE);
an instruction memory for receiving instruction pointers, for receiving an instruction pointer having a key, for generating an emulCAM instruction based upon the instruction pointer, and for integrating CAM entries corresponding to the instruction pointer directly into the emulCAM instruction,
wherein the PPE executes emulCAM instruction and executes the CAM entries as part of the emulCAM instruction execution.
